(19) United States
(12) Patent Application Publication
(10) Pub. No.: US 2009/0113549 A1
(43) Pub. Date: Apr. 30, 2009

(54) SYSTEM AND METHOD TO ANALYZE SOFTWARE SYSTEMS AGAINST TAMPERING

(75) Inventors: Hongxia Jin, San Jose, CA (US); Ginger Marie Myles, San Jose, CA (US)

Correspondence Address: LAW OFFICE OF DONALD L. WENSKAY, P.O. Box 7206, Ranco Santa Fe, CA, 92067, US

(73) Assignee: International Business Machines Corporation, Armonk, NY (US)

(21) Appl. No.: 11/923,521

(22) Filed: Oct. 24, 2007

(51) Int. Cl. G06F 11/00

(52) U.S. Cl. 726/25

(57) ABSTRACT

A system, article of manufacture and method is provided for determining the vulnerability to attack of a software system by generating a hybrid graph, the hybrid graph including an attack graph portion describing at least one potential attack goal on the software system and describing sub-attacks required to achieve the potential attack goal. The hybrid graph also includes a defense graph describing ways to defend against the potential sub-attacks. The hybrid attack-defense graph may be evaluated and a score may be calculated based on the evaluation.

### FIELD OF INVENTION

The present invention generally relates to tamper resistant software, and particularly to systems and methods for analyzing a software system against tampering.

### BACKGROUND

Software-based tamper resistance has been traditionally used to protect embedded secrets in military applications or by software companies wishing to protect an embedded license. More recently, with the increased usage of content protection systems by the music and movie industries, tamper resistance is being used in a broader spectrum of applications. Unfortunately, the use of tamper resistance can lead to complications. For example, knowing what elements should be protected and how to properly protect them requires expert knowledge not found on most software development teams. Also, it is not always clear what level of protection is actually provided by a particular tamper resistant implementation

These kinds of issues are especially pertinent to content protection systems whose software implementations must include robust tamper resistance to protect embedded secrets like encryption keys. A software license may specify consequences for a licensee who fails to provide an adequate level of tamper resistance. However, if a content protection system is hacked, because of poorly implemented software, there may be severe consequences for the entire content protection system and not just the licensee.

One example of this situation involves the Advanced Access Content System (AACS), which is a standards-based content protection system for the next generation high definition DVDs. Not long after it was introduced, hackers successfully analyzed a software player, extracted the secret keys, and redistributed those secrets on the Internet. This led to freely available movies in unprotected formats, which harmed the content providers. The reputation of AACS was also damaged at a time when it is trying to promote the wide-scale adoption of its content protection system.

Many standards-based systems require manufactures to certify that their implementations meet certain robustness levels in an attempt to prevent easy circumvention of the protection mechanisms. But most companies are reluctant to release their software to the standards body or an outside evaluation team due to potential intellectual property leakage. Consequently, it can be difficult for developers to determine if a protection mechanism is actually robust and which attacks it can protect against.

Accordingly, there is a need for techniques to facilitate the certification by software developers that their implementations are tamper resistant, without risking revealing protected aspects of the software. There is an additional need for software developers to determine if a protection is robust and to determine which attacks it can protect against.

### SUMMARY OF THE INVENTION

To overcome the limitations in the prior art briefly described above, the present invention provides a method, computer program product, and system for analyzing software systems against tampering and for self-certifying tamper resistant software.

In one embodiment of the present invention a method for determining the vulnerability to attack of a software system comprising: generating a hybrid graph, the hybrid graph including an attack graph portion describing at least one potential attack goal on the software system and describing sub-attacks required to achieve the potential attack goal, the hybrid graph including a defense graph describing ways to defend against the potential sub-attacks; evaluating the hybrid graph; and calculating a score for the hybrid graph based on the evaluation.

In another embodiment of the present invention, a method of comparing resistance against tampering of computer software systems comprising: creating attack computer graphs of how each one of a first and second software systems could be tampered with; forming a defense computer graph of how the first and second software system could be defended based on a corresponding one of the attack graphs; combining the attack computer graphs with the corresponding defense computer graphs into a hybrid attack-defense computer graph; evaluating each of the hybrid attack-defense computer graphs to determine a metric for each of the hybrid attack-defense computer graphs; and comparing the metric for the first and second computer software systems.

In a further embodiment of the present invention an article of manufacture for use in a computer system tangibly embodying computer instructions executable by the computer system to perform process steps for determining the vulnerability to attack of a software system the process steps comprises: generating a hybrid graph, the hybrid graph including an attack graph portion describing at least one potential attack on the software system and describing sub-attacks required to achieve the at least one potential attack, the hybrid graph including a defense graph describing ways to defend against the potential sub-attacks; evaluating the hybrid graph; and calculating a score for the hybrid graph based on the evaluation.

In an additional embodiment of the present invention a self-certification tool for software developers comprises: attack graph generator for receiving a computer software system and generating an attack graph representing how the computer software system could be attacked; query module for requesting information from the software developers regarding features of the computer software relating to the attacks; defense graph generator for generating a defense graph indicating ways to defend against attacks described in the attack graph using the requested information; and appraising unit for calculating a metric representing the resistance to attack of the computer software system.

Various advantages and features of novelty, which characterize the present invention, are pointed out with particularity in the claims annexed hereto and form a part hereof. However, for a better understanding of the invention and its advantages, reference should be made to the accompanying descriptive matter together with the corresponding drawings which form a further part hereof, in which there is described and illustrated specific examples in accordance with the present invention.

### BRIEF DESCRIPTION OF THE DRAWINGS

The present invention is described in conjunction with the appended drawings, where like reference numbers denote the same element throughout the set of drawings:

FIG. 1 is a block diagram of a typical computer system wherein the present invention may be practiced;

FIG. 2 shows a sub-attack graph in accordance with an embodiment of the invention;

FIG. 3 shows a defense graph in accordance with an embodiment of the invention;

FIG. 4 shows a semi-extended attack graph in accordance with an embodiment of the invention;

FIG. 5 shows a partial hybrid attack-defense graph in accordance with an embodiment of the invention;

FIG. 6 shows a hybrid attack-defense graph in accordance with an embodiment of the invention; and

FIG. 7 shows a flow chart of a process for analyzing a software system against tampering in accordance with one embodiment of the invention.

### DETAILED DESCRIPTION OF THE INVENTION

The present invention overcomes the problems associated with the prior art by teaching a system, computer program product, and method for analyzing software against tampering. In the following detailed description, numerous specific details are set forth in order to provide a thorough understanding of the present invention. Those skilled in the art will recognize, however, that the teachings contained herein may be applied to other embodiments and that the present invention may be practiced apart from these specific details. Accordingly, the present invention should not be limited to the embodiments shown, but is to be accorded the widest scope consistent with the principles and features described and claimed herein. The following description is presented to enable one of ordinary skill in the art to make and use the present invention and is provided in the context of a patent application and its requirements.

The various elements and embodiments of invention can take the form of an entirely hardware embodiment, an entirely software embodiment or an embodiment containing both hardware and software elements. In a preferred embodiment, the invention may be implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

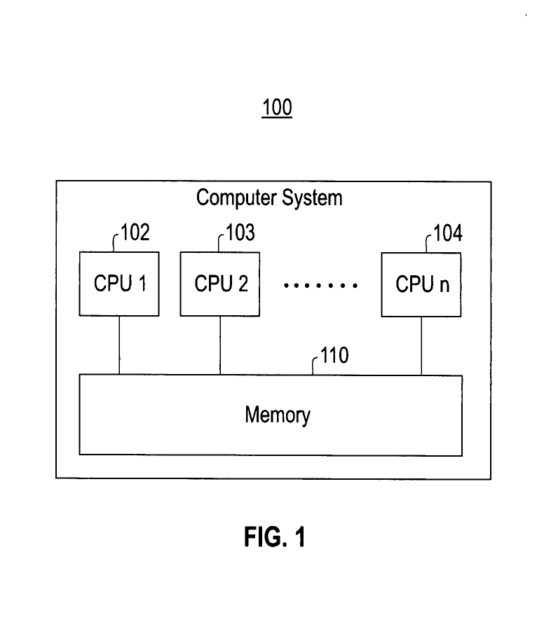

FIG. 1 is a block diagram of a computer system 100, in which teachings of the present invention may be embodied. The computer system 100 comprises one or more central processing units (CPUs) 102, 103, and 104. The CPUs 102-104 suitably operate together in concert with memory 110 in order to execute a variety of tasks. In accordance with techniques known in the art, numerous other components may be utilized with computer system 100, such as input/output devices comprising keyboards, displays, direct access storage devices (DASDs), printers, tapes, etc. (not shown).

Although the present invention is described in a particular hardware embodiment, those of ordinary skill in the art will recognize and appreciate that this is meant to be illustrative and not restrictive of the present invention. Those of ordinary skill in the art will further appreciate that a wide range of computers and computing system configurations can be used to support the methods of the present invention, including, for example, configurations encompassing multiple systems, the internet, and distributed networks. Accordingly, the teachings contained herein should be viewed as highly “scalable”, meaning that they are adaptable to implementation on one, or several thousand, computer systems.

The present invention provides a system and method of analyzing a software system against tampering. In particular, the present invention provides a way to enable the manufacturers, such as software implementers, to self-certify their implementation and measure the software resistance against tampering. The software designer creates a graph, which may be a tree in some embodiments. This tree is a graphical representation of how a software implementer's software can be broken. The root of the tree is the ultimate goal of the attack and the leaves of the tree are the primitive hacking events. Once this tree is built, the probabilities of the primitive events occurring are assigned. Those probabilities are used to calculate the probability for the occurrence of the hacking goal in the root. This gives the software implementers an idea of how resistant their software implementation is against tampering.

In some embodiments of the invention, automated tools are built and provided to the software developers to assist in the calculation of the root probabilities. A licensing agency can specify a threshold on the overall probability that the licensees must satisfy before they can release their software.

The values assigned to the leaf nodes can also be other types of metrics on the primitive hacking events, for example, the cost of that hacking event to succeed in terms of man-months, or man-weeks. In this case, the entire system's strength may be measured by how long it takes to break the whole system. Different metrics can reflect different aspects of the hacking events, and thus may give different types of guidance on the system.

When the present invention is used by an entity like AACS, all the licensees will implement the software with the same functionality (e.g. play back the content). In one embodiment, the licensing agency may create a sample tree on attacks for the licensees. The licensee can then refine the tree based on their own implementation. If an entity like AACS is going to give a sample attack tree, it can incorporate some guidelines on better implementing tamper resistant software into the leaf nodes, showing examples and possible ways to prevent the hacking events from happening. This would yield much more robust tamper resistant software than in prior art methods where the licensing agency simply provides a checklist on implementing tamper resistant software.

The self-measurement aspects of the present invention are not only useful in licensing, but also can be useful for any software developer who wants to know how secure their software implementation is. The aforementioned automated tool could be included in a suite of products provided by a software tool vendor.

A main component of the present invention tool is the attack graph, which has been extensively used in measuring and analyzing software reliability and network vulnerabilities. The attack graph, generally represented as a tree, is a graphical representation of how the system can be attacked. Each node in the tree represents an attack goal where the root node is the ultimate goal in attacking the system. For example, if we wanted to construct an attack graph for a program protected using software watermarking, the root node may be “remove watermark”. Each sub-node represents an attack which aids in achieving the parent attack. This breakdown of attacks into sub-attacks continues until the most basic attack is identified, which becomes a leaf node in the tree.

To evaluate the strength of the system the probability that the primitive attack succeeds is assigned to each leaf node. Using a bottom-up calculation based on minimal cut sets, the probabilities are propagated up to the root node. The value assigned to the root node is the probability the ultimate attack goal will be achieved, thus indicating the overall strength of the system.

Initial inspection indicates the attack graph model may be suitable to measure tamper resistance strength. However, this approach does not address important subtleties inherent to software tamper resistance:

1. To properly design tamper resistant software requires expert knowledge. This is also true with the attack graph construction, thus it is necessary to ensure the graph is built correctly.

2. One aim of embodiments of the present invention is self-certification. Because all software designers have motivation to pass the self-certification process, it is necessary to ensure that the values on the leaf nodes are assigned correctly.

The present invention comprises an evaluation tool that addresses these issues to provide a means of measuring the level of tamper resistance. In the following discussion, we detail the process of creating a hybrid attack-defense graph and illustrate how it is used on a tamper resistant software watermarking algorithm.

The evaluation tool of the present invention is based on the construction and evaluation of a hybrid attack-defense graph. This graph is built in a multi-step process beginning with the custom attack graph. The high level portion of the attack graph is built in a manner similar to prior art attack graphs as discussed above. The software designer or standards body, such as AACS, develops a high level graph describing how the software system can be attacked. At each level down from the root the attacks become more specific, with child nodes representing smaller attacks that aid in the parent attack. The leaf nodes identify the most basic elements that need to be protected. Examples of such leaf nodes include an embedded constant or a table of values. Each of the sub-graphs are annotated with AND and OR operations to indicate the combination of sub-attacks required in the parent attack. “AND” means that all of the multiple sub-goals need to be achieved in order to achieve the attack goal specified in its parent node. “OR” means only one of the sub-goals is necessary. In some situations the annotation may be “K out of N”, which means “K out of N” sub-goals needs to be satisfied.

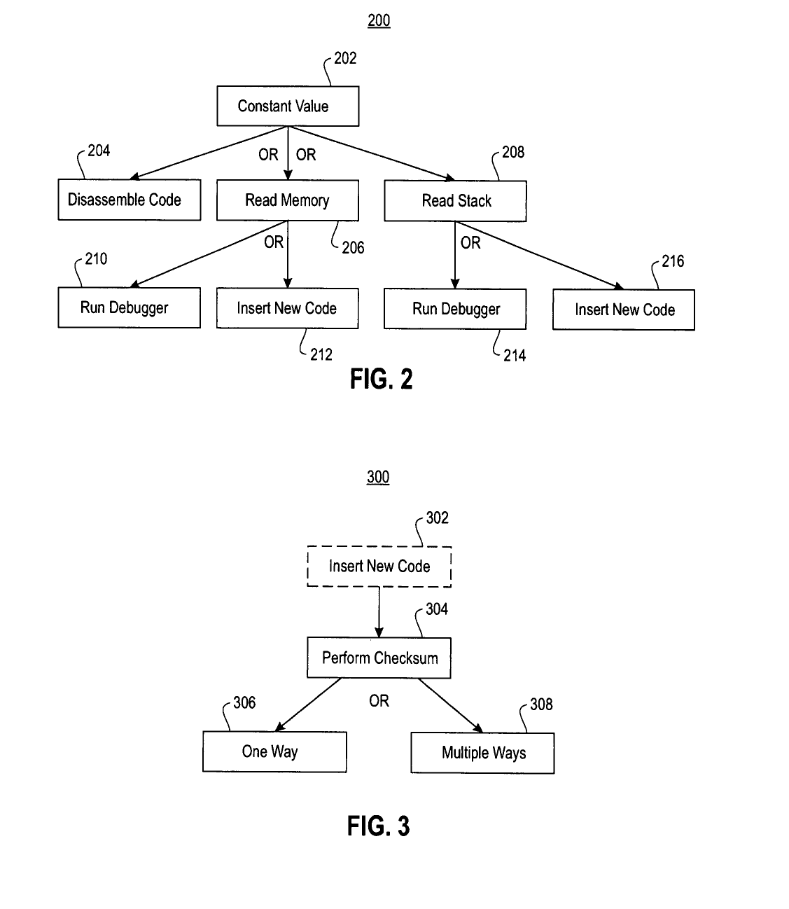

The second step in building the hybrid graph is to semi automatically expand the attack graph using the expert knowledge. In some embodiments of the invention, this expert knowledge is embedded in the system along with information obtained from the user. The present invention uses a systematic process in which the tool questions the user to determine the characteristics of each primitive element (i.e. leaf node). Based on this information, a sub-attack graph is iteratively built detailing the potential attacks for that element. FIG. 2 shows an example of this kind of sub-attack graph 200 expanded off a constant value basic element in the attack graph. If the user identifies the basic element to protect as a confidential constant value 202, the tool knows that the value can be extracted from memory, or from the stack as the program executes or by disassembling the code. Using this knowledge, three sub-nodes 204, 206 and 208 are added. Furthermore, the memory and stack nodes are expanded because each can be attacked using a debugger or by inserting new code. Hence, two additional sub-nodes are added to the read memory node, 210, and 212 and to the read stack node, 214 and 218.

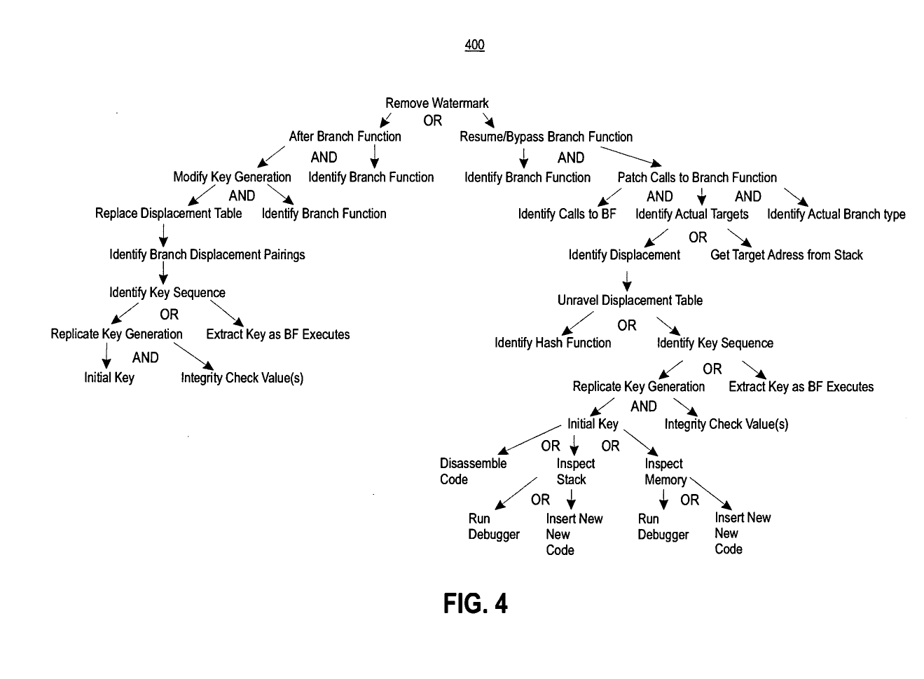

The final step is to build the defense portion using the expert knowledge embedded in the tool. At each leaf node in the attack graph, a defense graph is added indicating the mechanism which can be used to protect against that specific attack. FIG. 3 illustrates a defense graph 300 associated with the “insert new code” attack. In particular, to defend against the insertion of new code 302, a defense is to perform a checksum 304. Furthermore, the defense graph is expanded to indicate the defense can be implemented using a single checksum 306 or multiple checksums 308. Like the attack portion of the graph, the defense graph is annotated with AND and OR operations.

Using the hybrid graph and user input, the overall evaluation score may be computed in a two-step process. First the defense graph portion is evaluated in a bottom-up fashion. The evaluation process begins by assigning values to the leaf nodes based on expert knowledge embedded in the tool. These values are propagated up the tree based on the AND and OR operations. In the defense graph, the OR operation always relates to an implementation choice and eliminates one or more leaf node in each subgraph. For example, to evaluate the defense graph in FIG. 3 the user may be queried to determine if the checksum was implemented in one way or multiple ways. The AND operation is used to combine the values. When the graph is used to evaluate the probability the software will be compromised, AND represents multiplication. On the other hand, when the evaluation indicates the cost to defeat, AND represents addition. The evaluation score for each defense graph then becomes the weight assigned to the associated attack node. So the evaluation score for the perform checksum defense is assigned to the insert new code attack.

Finally, the attack portion of the graph is evaluated to produce the overall evaluation score for the tamper resistant software. This can be done using any evaluation approach. For example if we are evaluating the probability for the root attack goal to succeed, this can be done by using the traditional approach based on minimal cut sets. A minimum cut set gives a minimum set of successful primitive events necessary to satisfy the root. For example, we can use the Fussell-Vesely algorithm to identify minimum cut sets and calculate the score for the root. Once the minimal cut sets are identified, the final probability for the ultimate attack goal in the root to succeed is the Union of all the probabilities contained in each cut set. Various approaches to calculate of these Union probabilities may be employed in accordance with the present invention. The basic “inclusion-exclusion” approach is one technique that may be used. For example, in order to calculate the Union of two probabilities, P{A U B}=P{A}+P{B}−P{A and B}. Similarly, P{A U B U C}=P{A}+P{B}+P{A and B}−P{A and C}−P{B and C}+P{A and B and C}.

The techniques described above can be done at different granularity of the software. For example, it can be done for the entire software, or it can be done at a function level. If it is done at small granularity level, the above method can be iterated again at a large granularity level until it is done for the entire software or whatever final level desired.

To illustrate how the hybrid attack-defense graph can be used to evaluate tamper resistant software the techniques of the present invention have been applied the technique to a program that was watermarked using the Branch-Based watermarking algorithm. This algorithm is described in G. Myles and H. Jin, Self-validating branch-based software watermarking. In Proceedings of 7th International Information Hiding Workshop, pages 342-356. Springer, 2005, which is hereby incorporated by reference in its entirety. Using this algorithm a watermark is embedded by redirecting branch instructions to a specially constructed branch function. This function is responsible for generating the program's watermark and regulating execution. To prevent removal of the watermark tamper resistance is added.

To begin the hybrid attack-defense graph construction, the attack graph is first built. The ultimate goal in this scenario is to remove the watermark so “remove watermark” becomes the root of the graph. To remove the watermark a sub-attack would be to either alter the branch function so an incorrect watermark is generated or remove the branch function so no watermark is generated. Both of these attacks then become children of the root node. This process continues until the most primitive elements requiring protection are reached. In the case of the Branch-Based algorithm these are elements such as the initial key, the current key, the integrity check values, and calls to the branch function.

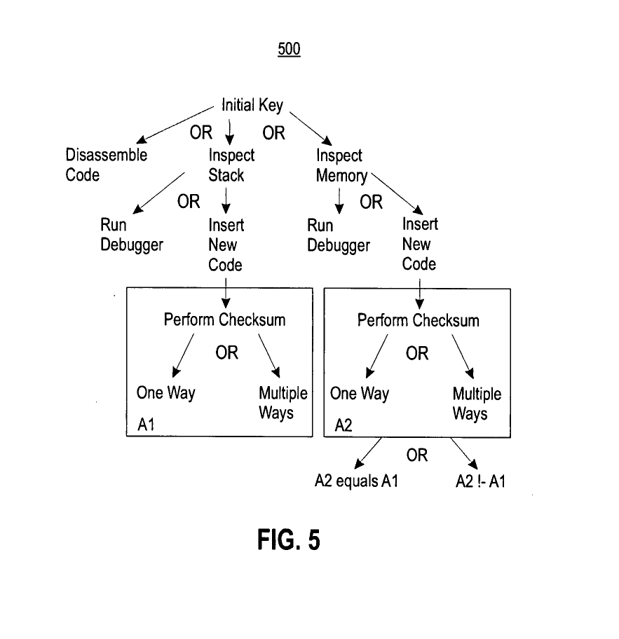

Next, the attack graph is systematically expanded at each of the leaf nodes. For example, for the node labeled “initial key”, the tool prompts the user to identify the type of element this node represents. In the present example, the element type is a confidential constant. Based on this information the subattack graph 200 shown in FIG. 2 is added to the graph. FIG. 4 illustrates the resulting high-level attack graph 400. The nodes in dotted lines represent the expansion associated with the “initial key” node.

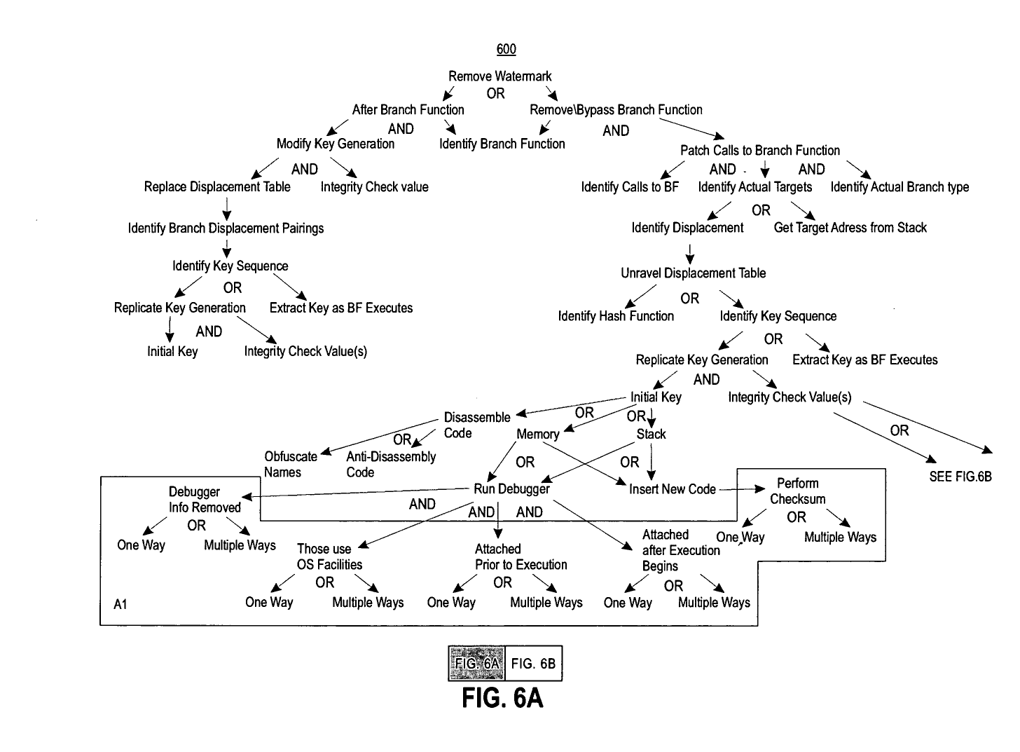

Finally, the defense graph portion is built in response to the complete attack graph. If we focus on one particular attack, for example, “insert new code”, we add the sub-defense graph shown in FIG. 3 into the graph. FIG. 5 illustrates the defense graph portion 500. In accordance with this embodiment of the invention, the tool also recognizes that the defense graphs associated with the two “insert new code” attack nodes are the same so nodes are added to the graph indicating this. FIG. 4 illustrates the defense graph portion.

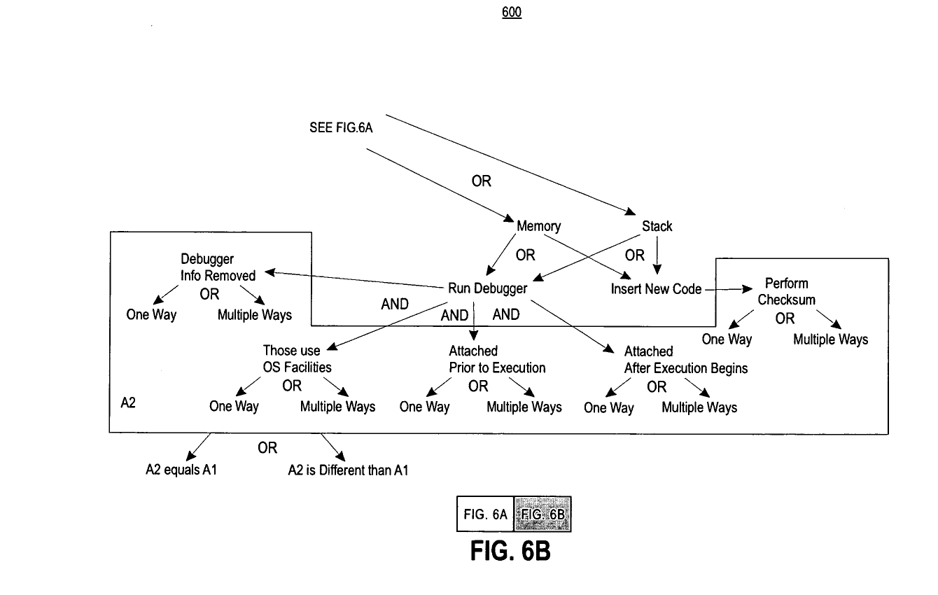

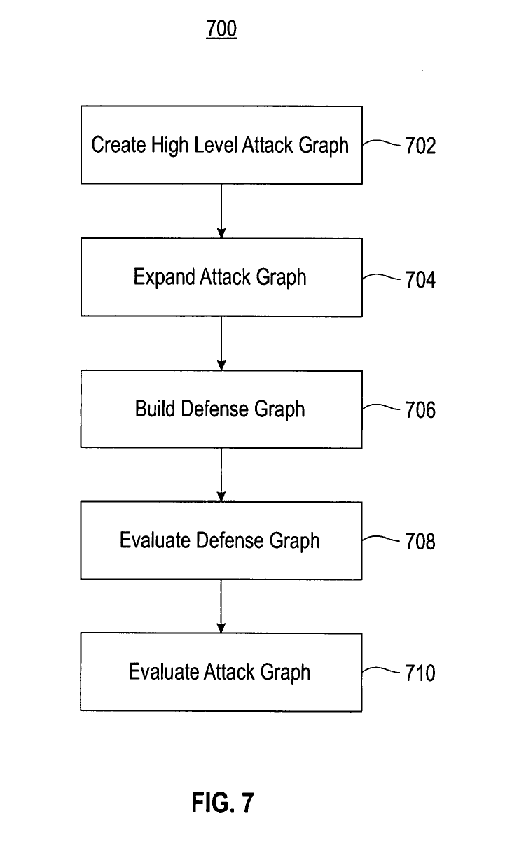

FIG. 6 shows the complete hybrid attack-defense graph 600 in accordance with other above-described embodiment of the invention. FIG. 7 shows a flow chart of a process 700 for analyzing a software system against tampering in accordance with one embodiment of the invention. First, in step 702, the software designer, or an AACS-like entity, comes up with a high level graph that describes how the software system can be broken and until it reaches to the basic entities that need to be protected from being attacked. For example, a constant value, or a table needs to be protected. The particular details will depend on the software system being protected.

In step 704 the tool in accordance with the invention automatically expands the graph into a more complete attack graph by iteratively expanding how the basic entities can be potentially broken. This is based on expert knowledge embedded in the tool. The user may be prompted by questions on the nature of each entity that needs to be protected. Based on the nature, the tool will iteratively expand potential attacks on the entity to build a sub-attack-graph on the entity. For example, if the entity one needs to protect is a confidential constant, we know the confidential value can be extracted from memory and stack by taking a snapshot of a running program, or use a disassembly. The node will be expanded accordingly. Further down, to attack memory, the attacker can run a debugger, or insert new codes, etc.

In step 706 continuing from the expanded attack graph, the tool automatically builds a defense graph, also based on embedded expert knowledge, to defend against different types of attacks. This process is also an iterative one. For example, to detect a debugger, one should remove debug information, and detect different type of debuggers. Furthermore, the user will be asked whether or not there are different ways to detect debuggers, etc.

In step 708, the defense graph is evaluated. In the examples described above, OR operation always only takes in the particular user choice on the question. It is exclusive. The AND operation may mean “addition” or “multiplication” depending on what type of value we are assigning, for example, if we are evaluating probability for breaking, AND means multiplication; if we are evaluating cost for breaking, AND means addition. This evaluation is a simple calculation bottom up based on “OR” and “AND” operations. The result of the evaluation of the defense graph for each attack becomes the weight assigned to that attack node.

In step 710 the attack graph is evaluated. This evaluation can be done by first identifying all possible paths leading to the root node and the set of basic attack nodes (minimal set) that are associated with each path. The overall value computed for the root node is the UNION of all the values on each minimal set identified.

The use of the hybrid attack-defense graph in accordance with the present invention for evaluating the strength of tamper resistant software has several advantages. First, the attack-defense graph enables a software developer to certify the strength of their implementation without revealing confidential implementation details. This makes it possible for license agencies like AACS to specify a threshold score which must be met before the software can be released. Moreover, using expert knowledge to build the defense graph and assign values to the leaf nodes prevents software developers from assigning values just to pass the certification process.

The second advantage is that it can help guide the software developer in their implementation. Determining what types of protection mechanisms should be used requires expert knowledge, but the defense portion of the graph provides the developer with this kind of information. Additionally, the technique provides a way to compare the strength of different implementation choices prior to investing in the actual implementation. For example, the developer can study the strength difference when the implementation of portion A1 and A2 in FIG. 6 are the same or different.

Furthermore, the graph model makes it possible to assign various metric values to the nodes and then evaluate the graph; for example, the cost to defeat the system in man-weeks or man-months. Using a variety of metrics can emphasize different aspects of the tamper resistant software and thus provide new insight and guidance to the developer.

The present invention provides a unified framework to measure the tamper resistant strength. It provides a way to compare different strategies to implement the same software, or compare the tamper resistance strength between different software. By drawing the tree on possible attacks, it provides software developers a chance to review the software design and identify the critical part of the software that is important to the entire security of the software.

Furthermore, since the present invention produces an overall evaluation score which can be publicly shared without leaking confidential implementation details, it can be used to compare various tamper resistance implementations.

In accordance with the present invention, we have disclosed systems and methods for analyzing software systems against tampering. Those of ordinary skill in the art will appreciate that the teachings contained herein can be implemented in many applications in addition to those discussed above. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

While the preferred embodiments of the present invention have been described in detail, it will be understood that modifications and adaptations to the embodiments shown may occur to one of ordinary skill in the art without departing from the scope of the present invention as set forth in the following claims. Thus, the scope of this invention is to be construed according to the appended claims and not limited by the specific details disclosed in the exemplary embodiments.

We claim:

1. A method for determining the vulnerability to attack of a software system embedded in a media player comprising:
generating a hybrid graph, said hybrid graph including an attack graph portion describing at least one potential attack goal on said software system and describing sub-attacks required to achieve said at least one potential attack goal, said hybrid graph including a defense graph portion describing ways to defend against said potential sub-attacks;
generating a tree graph wherein a root node represents said at least one potential attack goal on said software system and wherein non-root nodes on said tree graph include leaf nodes, non-root nodes describing potential sub-attacks on said software system, and non-root nodes describing defenses against said potential sub-attacks:
evaluating said hybrid graph by assigning a metric to said leaf nodes in said hybrid graph, said metric comprising a metric selected from the group consisting of a probability and a cost; and
calculating a score for said hybrid graph based on said evaluation by repeatedly combining said metrics for said non-root nodes to obtain the metric for higher level nodes until said root node is reached.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)
